(19) United States
(12) Patent Application Publication
(10) Pub. No.: US 2003/0084283 A1
(43) Pub. Date: May 1, 2003

(54) Digital broadcast system

(76) Inventor: Jeffrey Seth Pixton, Lynchburg, VA (US)

Correspondence Address: BLANK ROME COMISKY & MCCAULEY, LLP, 900 17TH STREET, N.W., SUITE 1000, WASHINGTON, DC, 20006, US

(21) Appl. No.: 10/233,680

(22) Filed: Sep. 4, 2002

Related U.S. Application Data
(60) Provisional application No. 60/333,505, filed on Nov. 28, 2001.
(60) Provisional application No. 60/316,279, filed on Sep. 4, 2001.

(51) Int. Cl. H04L 9/00

(52) U.S. Cl. 713/163

(57) ABSTRACT

A system for providing broadcasting services is disclosed. The system includes a digital channel database for storing a program from a broadcaster; a computer network for accessing and distributing the program as a data stream; a tower controller for receiving the program data stream from the computer network; and at least one transmitter selected by the tower controller to receive the data stream and to broadcast the program to end-user receivers.

The present invention relates to broadcast communications systems. More specifically, the present invention is a Broadcast Service Provider system that is used as the communication link between broadcasters and end-users. This application claims priority of U.S. Provisional Application Serial No. 60/316,279, filed Sep. 4, 2001.

### FIELD OF THE INVENTION

### BACKGROUND OF THE INVENTION

A conventional radio news or other information broadcast contemplates a single stream of news items or programming content spoken by a newscaster and simultaneously received by thousands of listeners. The newscaster must attempt to transmit items, which are of interest to the maximum number of listeners or viewers (end-users or consumers) in the limited time available. The end-users for their part must attend to many items, which are of no interest to them personally in order to catch the relatively few which are of interest. Additionally, the end-users must be available at the time the items are transmitted; delayed listening via recording is not very practical. The analog voice nature of radio broadcasts also makes them rather wasteful of scarce spectrum resources.

Some recent information services attempt to get around one or more of these limitations. News items are available in stored digital form to subscribers of facilities such as Prodigy(R) Tivo, SonicBlue Replay TV, and other interactive personal services. Other services even scan news wires for selected topics, then clip them automatically into folders for a recipient. Although such items can be accessed at any convenient time, these services require the recipient to be located at a computer terminal connected to the service, and the visual presentation requires enough of his attention that little other simultaneous activity is possible.

Solutions to the above problems still fall short in many respects. The recipient is tied to a computer terminal, must read a display, or attend to all items being broadcast. End-users could benefit greatly from a service that provides free and fee-based audio and visual broadcasting services on a per channel basis so as to individually tailor the needs of the end-users.

### SUMMARY AND OBJECTS OF THE INVENTION

A first object of the present invention is to provide a total and complete down link between broadcasters or content providers and end-users.

A second object of the present invention is to provide digital broadcasting of a variable codec type in the form of TV, audio, visual and data programming to RF receivers spread over a large geographical area.

A third object of the present invention is to enable a broadcast service provider system that incorporates robust dynamic modulation, on-the-fly codec upgrades, broadband, wired and wireless broadcasting, audio, video, and data-streaming into one black-box solution for electronics manufacturers, broadcasters and consumers.

A fourth object of the present invention is to enable a broadcasting system that increases the number of channels per transmitter that are available for broadcasting dynamically as two independent factors become more efficient: codec compression and RF hardware QAM density.

A fifth object of the present invention is to enable a broadcast service provider system in which end-users may be charged on a per-channel basis.

A sixth object of the present invention is to provide a broadcasting system that may be upgraded without major changes in hardware.

These and other objects and features of the present invention are accomplished, as embodied and fully described herein according to the invention, by a system for providing broadcasting services. Specifically, the system includes a digital channel database that stores a program data-stream provided by a broadcaster, a computer network for accessing and distributing the program to a number of tower controllers, and digital transmitters associated with the tower controllers for transmitting the program to end-users. The end-users receive the program via a digital receiver module that may be attached to electronic appliances such as digital TVs, MP3 players, cellular telephones, etc. Each part of the system may be software configurable so that data transmission standards may be upgraded without major changes in hardware.

Other objects, features and advantages of the present invention will become evident to one skilled in the art from the following detailed description of the invention in conjunction with the accompanying drawings.

### BRIEF DESCRIPTION OF THE DRAWINGS

FIG. 1 illustrates one embodiment of the system for providing broadcasting services according to the present invention;

FIG. 2 illustrates the information that may be displayed to an end-user of the broadcasting services;

FIG. 3 illustrates an array of transmitters for broadcasting digital signals to several end-user locations;

FIG. 4 illustrates one embodiment of the digital signal transmitter of the present invention; and

FIG. 5 illustrates one embodiment of the digital receiver module of the present invention.

### DETAILED DESCRIPTION OF THE INVENTION

The concept of a Broadcast Service Provider (BSP) is new and revolutionary. Like an Internet Service Provider (ISP) or a Cellular Service Provider (CSP), a BSP may charge users for the time of usage of a channel. The differences among the three are pointed out next.

An ISP sells connection services to its customers, who otherwise would have to install an Internet line directly to their home or place of business, setup servers, register Internet Protocol addresses, install routers and setup security measures. The cost would be very prohibitive to individuals. If they had any technical problems, they would be responsible for identifying, solving and fixing any issues in addition to all of the money spent on the setup.

Most individuals and businesses just want to be connected to the rest of the world so that they can accomplish their core goal, e.g., emailing, doing business, talking to others, gaming, etc. ISPs provide a worry-free way of reaching those core goals by distributing the cost of the bandwidth, servers, hardware, maintenance and repair to all subscribers on the system, thus taking advantage of economies-of-scale.

The services an ISP provides its customers may be summarized as follows:

1) Conveniently connect to Internet in house or business,

2) Providing numerous connection speeds and locations via 56 k, DSL, Cable, etc.,

3) Offering several cost structures based on consumer needs: number of email addresses, web space, bandwidth, etc.,

4) Setting up servers and routers to control traffic to ensure data reaches destination, and,

5) Maintaining network infrastructure hardware, IP addressing, and repairs/upgrades equipment.

The core reasons for consumer demands on ISP system may be summarized as follows:

1) Obtaining news on a local, regional, national, and worldwide scale,

2) Conducting E-commerce to purchase and sell desired goods,

3) Communicating with family and friends

Cellular Service Providers (CSPs) offer even more than an ISP in terms of cost per unit and the amount of expertise needed to accomplish a given task.

A CSP distributes the cost of base stations and phones across millions of users and over the course of several years of time. As is the case for ISPs, the economies-of-scale play a tantamount role in reducing the per-user cost of the service. Customers pay a base-fee for using the system plus additional charges commensurate with their usage.

The Services a CSP provides customers may be summarized as follows:

1) Providing access to a phone system from a wireless handset,

2) Providing numerous connection points throughout nation,

3) Offering several cost structures based on consumers needs: total minutes, voicemail, out-of-area coverage, etc.,

4) Setting up base stations and controlling voice traffic to ensure data reaches destination, and,

5) Maintaining network infrastructure hardware, and repairs/upgrades equipment.

The core reasons for consumer demand on CSP system may be summarized as follows:

1) Obtaining ready access to communicate on-demand,

2) Conducting business communications away from desk, office, or home

3) Communicating with family and friends

Both the ISP and CSP markets are profitable because consumers and the industries that created these relatively new markets made their own rules. Neither market had to contend with an infrastructure already in place and decisions about how things are to be done.

A careful study of the broadcasting industry reveals several rifts in the current mode of operation. Costs of broadcasting in numerous markets across the nation are so prohibitive that only major corporations can handle the imposing capital, equipment, and RF spectrum requirements. The result has been the creation of monopolies shared among a few, rather than a market in which many can participate.

Consumers are losing interest in traditional methods of broadcast reception in favor of more costly reception methods that are more specific to their needs and wants, such as cable and satellite services. The problem with the cable and satellite broadcast industries is that the expensive equipment and operations costs must be distributed evenly to all consumers, whether an individual consumer uses all of the services or not. Most consumers pay full cable service yet they only watch a small subset of the channels for which they paid for.

ISPs and CSPs charge customers for a specific usage. The present invention allows broadcasters to provide individualized broadcasting services, which in turn allows the BSP to charge customers for a specific usage. The BSP system of the present invention provides channels to broadcasters and content providers for transmission to individual consumers (end-users receiving the broadcasted signals). The consumers may be charged on a per channel basis by the broadcasters and content providers. As a service provider, as opposed to a content originator, a BSP supplies the market with the needed medium through which broadcasters and consumers can communicate. Broadcasters and content providers are then alleviated from expensive equipment setup, maintenance, costly repairs, and capital equipment expenditures. They can focus on their core business objectives: producing and distributing programming and content. Consumers receive numerous digital-quality free broadcast channels and can selectively pay for additional channels that meet their specific needs and desires, paying only for what they use.

The following are the services that a BSP may provide:

1a) Broadcaster: Access to a digital broadcasting system from anywhere in the nation,

1b) Consumer: Access to digital broadcasting from any consumer RF Appliance,

2a) Broadcaster: Numerous coverage schemes to suit broadcasters needs throughout nation,

2b) Consumer: Numerous content types in the form of audio, video, text, graphics, etc.;

3a) Broadcaster: Several cost structures based on needs: bit-rate, codec type, number of towers, etc.;

3b) Consumer: Free and paid services specific to needs: free radio and TV, pay-per-channel, etc.;

4a) Broadcaster: Sets up transmitters and controls traffic to ensure it reaches its destination,

4b) Consumer: Black-box solution to broadcast reception;

5a) Broadcaster: Maintains network infrastructure hardware, and repairs/upgrades equipment, and,

5b) Consumer: Maintains broadcasting compatibility long-term for consumer RF appliances.

The following are core reasons for customer demand on BSP system:

1a) Broadcaster: Low-cost barrier to any local, regional and nationwide market of consumers,

1b) Consumer: Low-cost banier to purchase RF appliance and receiver broadcasts nationwide;

2a) Broadcaster: All-in-one system which allows broadcasting of any content type: audio, video, etc.,

2b) Consumer: All-in-one system allowing reception of any content type: audio, video, etc.;

3a) Broadcaster: Upgrading of codecs and RF modulation to allow more channels and better quality, and,

3b) Consumer: On-the-fly upgrades allowing more channels and better quality.

Up until now, no system has been able to provide an open link between any broadcaster and all consumers.

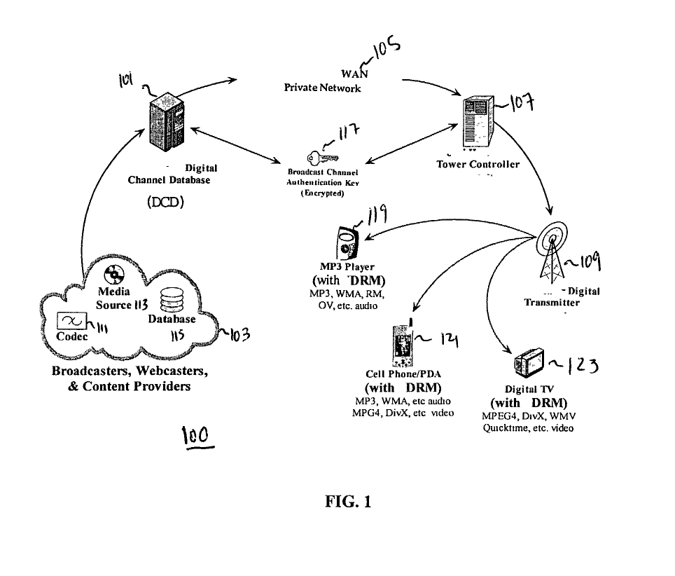

FIG. 1 illustrates the broadcasting process flow according to the system 100 of the present invention. The system 100 may include a Digital Channel Database (DCD 101); a number of content providers or broadcasters 103; a wide area network (WAN 105); tower controllers (TCs 107); digital transmitters 109; and a number of appliances connected with a digital receiver module (MP3 player 119, cellular telephone 121, and a TV 123).

The information to be broadcasted is referred to as the media source 113. The database 115 may include content data streams.

The media source may represent a Compact Disc, magnetic tape, microphone, ticker-tape feed (AP newswire, Stock info, etc.), hard drive, or any medium through which content can be transferred or converted to a data-stream. The database 115 represents the stored content of the broadcaster/webcaster/content provider which can include programming content (such as audio files—like MP3 or WMA—, video files—like MPEG2, MPEG4, DivX—, text files, etc.), advertising, and any other files the broadcaster/webcaster/content provider may wish to archive or store. The database 115 is not necessarily on-site with the broadcaster.

The DCD 101 mat also store programming content and advertising for purchase by the broadcasters. For example, a broadcaster could use the DCD 101 as its studios database of the programming content. The broadcaster would simply queue up an order in which its programming and advertising should be played, and control the transmitting of its data-stream remotely from its location office. The data-stream would then originate from the DCD 101 and move directly to the tower controllers, removing the need for a continuous internet link in between the broadcaster and the DCD 101.

A codec 111 may be transmitted to end-users in order to upgrade a codec previously stored in the end-users digital receiver. In general, the broadcaster 103 provides the broadcast service provider (BSP) with the data-stream from the media source to be transmitted to the end-user. The BSP may store the media or program in the DCD 101 before transmitting it to the TCs 107 via the WAN 105. To ensure security, an encryption key 117 may be required to decode the information sent over the WAN 105. The TCs 107 may then select the towers 109 that will broadcast the program. A detailed explanation of the system 100 follows.

1. Digital Channel Database

The DCD 101 may be defined as the collective group of servers that reside at the core of the BSP system. Any company, consortium, or individual can use the BSP system to transmit content to consumers, by sending the data-stream of content from the broadcasters studio to the DCD 101. A software package is provided by the BSP to content providers and broadcasters 103 to facilitate this process. For example, a modified version of a Shoutcast server software would create an avenue for Webcasters to divert one of the Internet-based data-streams directly to the DCD 101 for dissemination, while allowing users to continue to hook up via the web to the Shoutcast server. An example of the modified version includes the labeling of one of the DCD servers by the web/net cast server software as a permanent client of the data-stream.

In order for broadcasters or content providers to reach their desired audience, they must have control over where the signal is transmitted. The DCD 101 serves this function by providing the content provider with 4 types of information:

1. Bit-rate availability in a given location,

2. Graphical view of the RF saturation pattern,

3. Cost of service per tower, and

4. Demographics of consumers in the target area.

Bit-rate Availability

The bit-rate availability may be calculated based on the proposed bit-rate of the programming content coming from the broadcaster. For example, if a content provider want to transmit 128 kbps MP3 files, then the DCD 101 determines if that much bandwidth is available on every tower that the content provider wants to broadcast from. If the bandwidth is not available on certain or all towers, the DCD 101 returns the available bandwidth parameter back to the content provider. The broadcaster could then make adjustments according to the bandwidth space available.

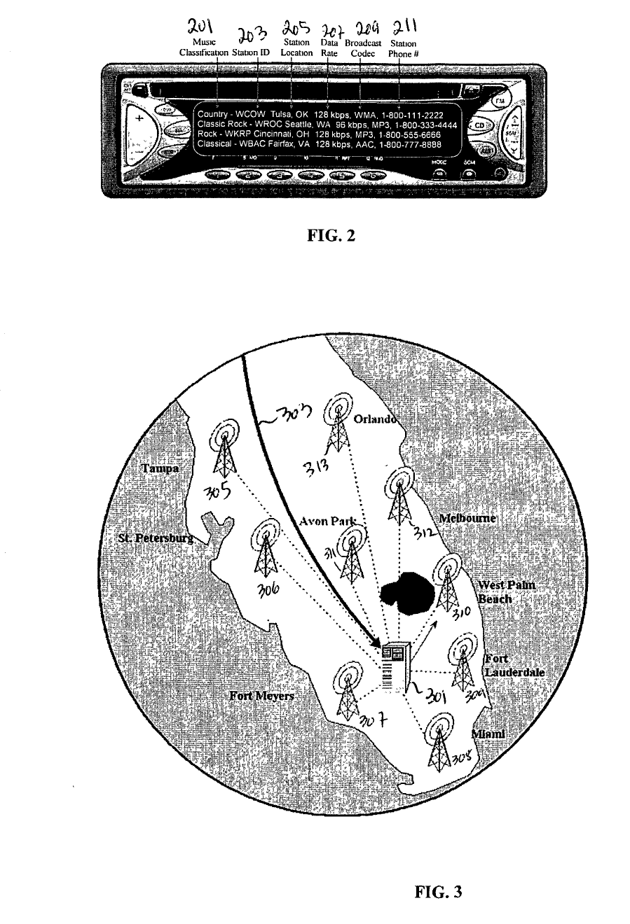

Bandwidth requirements may be determined by adding three values: the total data-rate of the broadcast data-stream, additional text information the broadcaster wants to add, and a small amount of RF overhead. Examples of additional text information that also take up bandwidth are, geographic location, telephone number, codec type, bit rate, currently playing song/video title and artist, purchasing information, etc. Shoutcast software, as viewed from the Winamp audio player, is an example of displaying this type of additional information. FIG. 2 illustrates how the user interface might appear on a car stereo/CD player.

The information that may be displayed includes music classification 201, station ID 203, station location 205, data rate 207, broadcast coder 209, and station's phone number 211.

Graphical RF Saturation View

A content provider would pay exactly for what it wanted in terms of coverage area, while leaving the technical issues of broadcasting to the BSP.

A graphical view of the proposed broadcast areas would reveal a detailed picture of exactly where consumers could receive the channel. If “white space”, or dead areas existed in the coverage pattern, the content provider could modify or expand the desired coverage pattern to reach the desired areas, similar to the way the Cellular Service Providers package their coverage areas.

The technical solution for the graphical view is solved by loading the DCD 101 with a detailed set of Geographic Information System (GIS) topography and then calculating RF penetration based on previously successful RF algorithms. For example, mathematical algorithms from engineering software designed to aid in cellular antenna placement and two-way radio communications tower placement can be used. Obstacles, such as large buildings, will be added where appropriate. Previous database applications of GIS topography to establish saturation patterns in the environment have been successfully used in a similar manner by the US Navy for determining environmental changes before and after weapons testing.

The database serves as an aid to systems engineers in placing new towers and moving existing towers. Resolution of the graphical view may be below 0.5 miles. Selection of the desired coverage areas by broadcasters can be based on city, county, state or geographic boundaries. Broadcasters may adjust and modify coverage areas on the web by changing the parameters of coverage on the database and performing a new query. For example, a Seattle-based broadcaster can also reach other urban markets like Chicago, Dallas, Atlanta, San Francisco, and Washington, D.C. through the BSP system.

Cost of Service

Content providers may reach heavily guarded markets for a nominal monthly cost. As discussed above, with the use of the BSP system, any content provider can phase out its own broadcasting equipment and focus on content creation and advertising revenue generation.

At the time of the service request, broadcasters will know exactly the total monthly, quarterly, and annual cost of broadcasting. This enables the broadcasters to determine where to broadcast (i.e., whether it is feasible) and prioritize the audiences to be reached.

Consumer Demographics

The final piece to the DCD 101 is the demographic data maintained on a nationwide basis. Broadcasters may use the data to gain knowledge of several key parameters about the proposed audience: gender ratios, racial cross-sections, age groups, urban population, suburban populations, rural population, average annual income, and many other bits of information. This information is also relevant to broadcasters with respect to selling and raising advertising revenue from companies looking for a specific consumer audience.

Additional Aspects of DCD

The DCD 101 may reside on a nationwide, mission-critical, private Wide Area Network (WAN 105). Once the data-stream from the broadcaster reaches the DCD 101, the data-stream can be forwarded to all specified transmitters or cached for gradual release at a later or specified time. When the data-stream is needed at a transmitter, the DCD 101 forwards it to the appropriate Tower Controller ( TC 107) across the WAN 105. Broadcasters may choose to upload several hours' to several days' worth of programming onto the DCD 101. The DCD 101 would then forward the data-stream during the appropriate hours according to the parameters set by the broadcaster. For example, a broadcaster may choose to queue up a total of 24 hours of programming and then upload the data to the DCD 101 in a matter of minutes. The database DCD 101 then manages the time to begin transmitting that queue of data across the WAN 105 to the transmitters through the TCs 107, thus alleviating the need for a constant stream coming from the broadcaster.

2. Tower Controllers

Another element in the BSP system is the TCs 107, which may be defined as mission-critical servers. After a data-stream arrives at any TC 107 from the DCD 101, the TC 107 attaches security and control parameters to the data-stream before forwarding the data-stream to the transmitters 109. The TC 107 performs four significant tasks: 1) adds encrypted authentication on the data-stream, 2) adds any required codecs, 3) sets the RF controls on the transmitter for this particular data-stream, and 4) adds pay-per-channel receiver identification if applicable.

Encrypted Authentication

An encrypted key that is decipherable by a receiver identifies every data-stream. The key may be 128-bits in length and serve in the following ways: prevent receivers from installing harmful contents from the codec part of the data-stream, allow control of digital rights management, and authorize the decoding of pay-per-channel services.

Codec Deployment

When a broadcaster decides to use a new codec, the codec can be deployed to all receivers for installation and use through the RF data-stream. A codec may be defined as software program that decodes a compressed stream of digitized data back into its original data-file format. For example, station XYZ may decide to switch from an older version of the MP3 codec to a newer version that can produce the same audio quality at a lower bit-rate. The old version may have required 128 kbps but the newer codec uses 96 kbps. To update the codec, the broadcaster may send the new codec to the DCD 101. The database forwards the codec to the appropriate TCs 107 and whenever that particular broadcaster's data-stream comes through with the tag to attach the codec, the uploaded codec file would be integrated into the RF channel on the transmitter.

Setting RF Control Parameters

The present invention may include the use of software controlled RF transmitters. Transmitter hardware is expensive and not easy to upgrade. The rate at which RF modulation technology progresses would require a hardware update about every 18 months to stay up with advances at a reasonable rate. By using software controlled RF modulation at the transmitters, parameters may be modified without any hardware updates for a longer period of time. For example, the BSP system may program the QAM modulation rates from the TC 107. Spacing of the channels may be dynamically allocated as well as other parametrics that control the way the transmitter and receiver communicate by the TC 107.

Broadband bandwidth over the WAN from the TC 107 to the transmitters requires an accurate calculation of the total number data-streams and the total bandwidth of the data-streams to control costs of broadband and maximize usage. There may be two ways to route the data across the WAN 105. The first is to use linearity and forward the data from transmitter to transmitter until all nodes have been reached. This method is susceptible to breakdown unless the data traffic can be re-routed around a node that is failing. The second method requires a point to multipoint broadband link from the TC 107 to every transmitter. However, this would represent an inefficient use of broadband spectrum. A formula for calculating the bandwidth from the TC 107 to all transmitters 109 can be written as, Ch·Dr·Tc=Total kbps, where Ch represents the number of channels, Dr represents the total average data rate per channel, and Tc 107 represents the number of transmitter connections. For example, if one TC 107 were forwarding 26 data-streams to 10 different towers, and the average data-stream rate was 160 kbps per channel, the formula would read:

26“channels”·160“kbps”/“channel”·10=Total“kbps”

41,600“kbps”=Total“kbps” or 41.6 Mbps=a T3 connection (<44 Mbps). As shown, it would be difficult to get numerous channels to many transmitters 109 without an enormous amount of broadband bandwidth. The broadband WAN 105 is therefore preferably linear in its design with the ability to re-route around any node that is not functioning properly.

Below is a list of broadband connection types and speeds for calculating the broadband requirements:

T1—1.544 megabits per second (24 DS0 lines)

T3—43.232 megabits per second (28 T1s)

OC3—155 megabits per second (100 T1s)

OC12—622 megabits per second (4 OC3s)

OC48—2.5 gigabits per seconds (4 OC12s)

OC192—9.6 gigabits per second (4 OC48s)

OC768—40 gigabits per second (Dense Wavelength Division Multiplexing—future technology)

Pay-per-channel

When a broadcaster elects to use a Pay-Per-Channel (PPC) option, the TC 107 adds the ID of the receivers that are authorized to decode the PPC data-stream periodically. The receiver ID may then be followed by an encrypted key specifying to the receiver which of all the PPC data-streams it is authorized to decode. The TC 107 keeps track of 3 pieces of key information: the data-stream authentication key, the specific receiver ID key, and the PPC authorization key.

3. Digital Transmitters

The Digital Transmitters (DT 109) may be defined as software controlled RF signal transmitters 109. They may use five parametrics sent by the TCs 107 for every channel. The five channel parametrics are 1) channel center frequency, 2) channel width, 3) subcarrier spacing, 4) symbol rate, and 5) frame rate. Once these are set, they do not need to be re-transmitted by the TC 107 until a change is required. The five parametrics for every data-stream may be transmitted via a single control channel that constantly outputs all of this information for every channel. The control channel is referred to be the Radio Frequency Allocation Control (RFAC) channel. The transmitters 109 may also receive specification for RF power output from the TCs 107.

Channel Authorization

The Digital Authentication Key (DAK) may be defined as the key created by the TC 107 for every channel. The DAK is identified and decrypted by the transmitter 109 to verify that the data-stream is legitimate and that the decryption key is working. If there is a problem, the transmitter 109 informs the TC 107 that the decryption process has failed. The TC 107 may then proceed in the following order to resolve the problem: 1) retry with a new DAK, 2) verify other DAKs are working on other channels, then 3) shut off transmission of the channel at the DT 109 and notify the DCD 101 the DAK is failing on the transmitter. Use of the DAK in this manner prevents tampering by outside sources and ensures that the receiver decryption scheme is working. The DT 109 transmits the DAK of every channel through the RFAC channel to ensure that consumer products do not decode any harmful or unauthorized data-streams.

Transmitter Arrays

Traditional transmitters 109 in both the analog and digital realms are designed and operated at very high RF power levels to maximize the coverage area and to minimize the number of repeaters necessary to cover larger areas. The creation of high-speed broadband networks antiquates this notion and necessitates a re-evaluation of the 50+ year-old practices. The DTs 109 of the present invention can be placed alongside other transmitters 109 on radio antennas, TV antennas, cellular towers, building tops, etc. Arrays of DTs 109 require lower electrical power consumption and have a great advantage over large high-power analog transmitters 109 that consume more electricity per square mile of coverage. A radio receiver is able to automatically tune to a different channel should the same radio station be using a different channel in a different geographical area. FIG. 3 illustrates the concept of a tower array set in the south of Florida.

Another benefit of tower arrays is the real-time RF power output adjustments that can be made by the TC 107 to compensate for a particular tower/transmitter that is down for maintenance, power outage, or other reasons. Transmitter arrays and TC 107 server clusters provide a significant amount of high-reliability and high-availability for any broadcaster looking for a true digital convergence broadcasting solution. In FIG. 3, the server 301 in the center of the graphic represents a single TC 107 for the region. The line 303 represents the broadband backbone coming from the DCD 101. Each of the towers 305-313 may be connected directly to the TC 107. Any broadcaster desiring to reach the southern Florida markets would be able to select, through the DCD 101, which towers they wanted their data-stream transmitted from.

Software Controlled Transmitters

Software upgrades and patches may be sent from the TCs 107 to the transmitters 109 in order to improve digital modulation schemes, security and system efficiency. This can be done via the WAN 105. Transmitter hardware does not need to be replaced when new modulation methods and techniques become available, such as the error correction methods, channel-coupling modes, and other RF parametrics. The TC 107 servers may reprogram and update the transmitters 109 remotely via the WAN 105. A Unix-based environment may be used to accomplish this because of its inherent ability to shutdown specific services, run updates, and then restart the services without re-booting the entire operating system. Certain versions of Unix also provide a stable, mission-critical certification for use in operations where 6 sigma (i.e., 99.999%) reliability is imperative.

4. RF Transport Method

The RF transport method of the present invention may be defined as the radio frequency link between the transmitter and receiver. It handles three critical aspects of broadcasting in the RF spectrum: RF spectrum availability, RF modulation bandwidth, and data compression efficiency. There are several minor factors as well, but only one worthy of note here: susceptibility to intentional, destructive interference. The system of the present invention is capable of providing robust and dynamically controlled RF carriers, efficient narrow-spectrum management, and incorporation of improved codecs.

RF Spectrum Availability

RF spectrum can be added selectively across the array of transmitters 109 where a certain region of the RF spectrum is available in one area but not available in other parts of the country. Channels may be added to the BSP system. Through the software controlled transmitter parametrics and the RFAC channel. Selectivity of RF space is relevant in handling the load requirements in areas with higher demand by broadcasters and consumers. For example, highly populated urban areas (1.5 million people) may require 3-4 times the amount of channel space used by less populated areas (75,000 to 100,000 people). If certain RF space used by any BSP channel becomes unusable, the DCD 101 moves the affected channels to other available RF spectrum and transmits the changes to the receivers through the RFAC. The transmitters 109 report continuity of channel performance by monitoring the RF spectrum in use by the BSP for harmful interference. Changes made to channel allocation are reported back to the DCD 101 to maintain the nationwide network of channel usage and availability.

RF Modulation Bandwidth

BSP RF channels are not necessarily discrete in size. A BSP channel is as wide as it needs to be in order to carry the payload. Once the bit-rate of the payload is deterrmned, the channel width is specified based on the calculated pay load. The present invention may make use of a basic unit for measuring a channel size and for relaying that information to the receivers. Describing the combining process of the BSP channel blocks is simplified by the use of a few terms. These terms represent a mathematical unit in the RF spectrum for use in BSP digital broadcasting, similar to the way Hertz (Hz) or Watts (W) are used to define cycles per second or power output. The base unit, for purposes of the present invention, for the channel size is 2 kHz and may be called a Quadra Digital Channel (QDC) or “Brick”. Eight Bricks combined form a channel 16 kHz wide called a Biquartic Digital Channel (BDC) or “Corbel”. Bricks and Corbels may be combined and added together as many times as needed to obtain the desired bandwidth on the RF carrier. The abbreviated form of these units may be written “Brk” for Bricks and “Crb” for Corbels. The following table provides a listing of the bandwidth sizes:

| Number of Bricks or Corbels | Channel Bandwidth in kHz |
|---|---|
| 1 Brk | 2 |
| 2 Brk | 4 |
| 3 Brk | 6 |
| 4 Brk | 8 |
| 5 Brk | 10 |
| 6 Brk | 12 |
| 7 Brk | 14 |
| 8 Brk | 16 |
| 1 Crb | 16 |
| 2 Crb | 32 |
| 3 Crb | 48 |
| 4 Crb | 64 |
| 5 Crb | 80 |
| 6 Crb | 96 |
| 7 Crb | 112 |
| 8 Crb | 128 |
| 9 Crb | 144 |
| A Crb | 160 |
| B Crb | 176 |
| C Crb | 192 |
| D Crb | 208 |
| E Crb | 224 |
| F Crb | 240 |
| 10 Crb | 256 |

and so on . . .

Bricks and Corbels may be written in decimal form where the number to the left of the decimal represents Corbels and the number to the right represents Bricks. The combined unit, Crb+Brk, may be written “cb” and represents the BSP channel unit Corbel-Bricks. The following examples illustrate this naming scheme:

1.2 cb=1 Corbel plus 2 Bricks=16 kHz+4 kHz=20 kHz

2.4 cb=2 Crb plus 4 Brk=32kHz+8 kHz=40 kHz

5.7 cb=5 Crb plus 7 Brk=80 kHz+14 kHz=94 kHz.

12.0 cb=12 Crb plus 0 Brk=192 kHz+0 kHz=192 kHz

Writing 6.9 cb (96+18=114) is meaningful but not correct because of two reasons, first, it can be written 7.1 cb (112+2=114) and, second, the number must convert easily into hexadecimal. The corresponding number of units of Corbel-Bricks to specify the bandwidth of a particular channel is attached to the Channel Frequency Identifier (CFI). The CFI specifies the starting or center frequency of a BSP channel. For example, a BSP channel at 470.262 MHz with a bandwidth of 156 kHz would be written in decimal form as “cfi470.262+cb9.6”.

If a BSP channel exists using a 128 QAM rate, it would carry 15% more data than a channel using 64 QAM, so the channel using 128 QAM can be narrower than the 64 QAM channel carrying the same data. This effectively increases the amount of channels that can exist in a finite amount of RF space, every time the RF modulation rate is increased. Advancements in solid state Digital Signal Processors (DSP), Integrated Circuits (IC) and System on Chip (SoC) devices enable the dynamic BSP modulation standard to take form. Further advancements in these areas will allow higher modulation densities to be used freeing up more RF space for additional channels. Another key factor for RF spectrum availability is the continual development to decrease the required bit-rate for the data-stream by improving the efficiency of data compression.

Data Compression Efficiency

Digital broadcasting according to the present invention is not limited to any one codec or group of codecs. Broadcasters produce their programming content with whatever particular codec they prefer and transmit a data-stream to the DCD 101 via a broadband Internet connection. The DCD 101 authenticates and disseminates the data-stream to the transmitters 109, which place the data-stream onto an RF carrier. During this process the broadcaster identifies the codec type of the data-stream to the DCD 101. If the broadcaster so chooses, the codec may be transmitted via the RFAC channel in association with that particular broadcasters data-stream. Every BSP receiver is capable of stripping off the codec from the RFAC, authenticating the codec's legitimacy through the DAK, installing the codec into the library of codecs on the receiver, and then playing the original content from the broadcaster using the new codec. This process is transparent to the consumer.

The broadcasters can take advantage of codec compression efficiency advancements by transmitting their preferred codecs to the consumers. For example, when the MP3 codec first came out, it required 196 kbps to maintain near-CD quality. Current MP3 codecs are near-CD at 128 kbps or even 96 kbps. The latest Windows Media Audio (WMA) codec from Microsoft can also achieve near-CD quality between 64 and 128 kbps. As this efficiency of compression increases, broadcasters using the BSP system of the present invention can incorporate codec advancements into their data-streams, reducing the cost of the channel and freeing up more space for other channels. If a consumer wants to playback the recorded broadcast on a computer, the proper codec will have to be installed from either the receiving unit or downloaded from a website hosted by the BSP.

Incorporating newer codecs is important for 3 reasons: 1) RF channel widths can be reduced allowing more channels to exist, 2) narrower channels cost less to broadcasters, and 3) evolving compression standards can enable continuous improvement in quality and content type. For example, MPEG-4 codecs, such as DivX, enable near-DVD quality compression at 700-800 kbps. Video codecs capable of compression down to 250-300 kbps would only require an RF channel bandwidth of 80-120 kHz. Such narrow bandwidths allow for hundreds of digital TV channels through the BSP broadcasting system.

Intentional Destructive Interference

Spread-spectrum standards boast of resistance to all of the major drawbacks of wireless telecommunications, but are limited in two ways. The first limitation is the finite number of Walsh/PN codes that can be used as subchannels on the main RF carrier. Spread-spectrum transmission necessitates a fixed, static, and continuous RF channel space to operate in because it uses logical, code-based subchannels on a single carrier. The second limitation for spread-spectrum is its inability to support software-based dynamic re-allocation of channel usage and size. Dynamic changes to the modulation structure and size of the spread-spectrum channel are highly undesirable, because of the inefficient way of transmitting such changes to the receiver. Software controlled re-allocation of spread-spectrum would require an excessively complex system to purge or add certain Walsh/PN codes whenever RF spectrum availability and bandwidth increased or decreased. BSP radio overcomes these obstacles through a software based re-configurable standard using a version of Pulsed Orthogonal Frequency Division Multiplexing (P-OFDM). OFDM overcomes Spread Spectrum technology because OFDM allows for the addition and subtraction of RF subcarriers at any time, creating a channel that may be adjusted to be wider or narrower. For example, if an RF channel is 100 kHz wide and has 100 OFDM subcarriers, 25 of these subcarriers could be changed to create another channel that is 25 kHz wide, leaving the original channel with 75 subcarriers. This change in the hardware of the transmitter and receiver can be easily implemented through software-controlled ASICs. This does not create a complex system when implementing dynamic reallocation because dynamic changes to the channel structure in OFDM are made by simply defining the start and stop point of the channel in the RF spectrum, or by specifying the center frequency of the channel and the frequency range above and below needed to define the channel size in Hz.

The primary concerns of narrow-channel standards versus spread-spectrum standards in terms of broadcasting are multipath, fading and cross-talk problems generally associated with non-spread-spectrum receivers. This is especially true when an intentional destructive interference pattern is created to undermine a BSP broadcast channel. The present system overcomes these obstacles by monitoring all broadcast channels at the transmitter and dynamically reassigning channels if and when interference is detected. When a channel is reassigned due to interference, the broadcast data-stream is shifted to an interference-free channel and the system temporarily excludes the use of the bad channel until the interference no longer exists. All BSP receivers are notified of these changes through the RFAC channel. The ability to dynamically manage channel allocation protects the system from intentional and incidental destructive interference.

Modulation Scheme

The BSP Digital standard modulation scheme is based on Quadrature Amplitude Modulation (QAM) techniques. In one embodiment of the present invention, the BSP may use 64 QAM as the modulation rate. Transmitters and receivers are software re-configurable to handle QAM modulation rates between 16 and 512. Every Quadra Digital Channel (QDC) is simply a building block for combining RF spectrum to make up a payload carrying data-stream, which can accommodate a variety of bit-rates. For example, a broadcaster can change from 64 kbps audio programming to 200 kbps video programming by purchasing the appropriate amount of QDC bricks and BDC corbels from the BSP, until sufficient RF bandwidth is produced. Coupling of channels progressively in this manner is accomplished through information passed along the RFAC from every transmitter. Each BSP broadcast channel may contain three major segments: Digital Data Stream (DDS), Codec Data Stream (CDS), and Key Data Stream (KDS).

Digital Data Stream

The Digital Data Stream (DDS) is host to the payload, and varies in width depending on the data rate of the data-stream coming from the broadcaster. The data-stream may be a compressed stream of data for which the broadcaster has purchased RF bandwidth. The broadcaster's compressed data-stream passes through the DCD 101 onto the appropriate transmitters 109 for broadcasting on specified channels. The transmitters 109 transmit the DDS payloads according to bandwidth specification set by the TCs 107. The bandwidth specifications are developed and calculated by the database when the broadcaster signs up for service.

Codec Data Stream

There are two preferred ways to transmit a codec to receivers. The first is to attach the codec to the RFAC for all receivers to pick up. The second is to use the CDS segment on the channel itself. When the receiver detects a codec in the CDS segment, the receiver parses the codec from the DDS, checks the DAK and stores the codec for current and future use. When no codec is present on the data-stream, the CDS segment is not used and is indicated by the RFAC for that specific data-stream. When broadcasters desire to use an updated codec, such as MP3, WMA, OV, AAC, RA, MPEG4, AVI, DivX, etc., the TC 107 indicates to the transmitter to transmit the codec in either the RFAC itself or load it into the CDS segment.

The RFAC and CDS segments may continually transmit a codec until it is determined that the codec is no longer needed in the RF data-stream. The codec only needs to be installed once on any given receiver, so the codec itself may contain an ID flag specifying the codec type and revision. The receiver continually receives the codec from the RFAC or CDS segment, and therefore, may identify that a particular codec is already installed and take no action. Other ways to transmit the codec to the receiver are also possible.

Key Data Stream

The Key Data Stream (KDS) segment may include the broadcaster identification, channel authentication, and several key flags for the receiver to interpret. BSP enabled receivers may first resolve the KDS segment before interpreting the data contained in the DDS and CDS, although all of the channel data might be demodulated at this point. The KDS segment may be identified by a fixed delimiter based on the “cfi+cb” information from the RFAC channel. The KDS can be either a fixed size, independent of the channel bandwidth, or a fixed percentage of the total BSP channel. The KDS segment may host several digital “keys” that provide information about the broadcaster and the BSP channel. These digital “keys” may include FCC identification (if required), station name, geographical location, CDS usage, CDS size, channel coupling information, and any authorization keys that are needed, such as the pay-per-channel data. Additional “keys” may be added when a need arises. Information about the content of the data-stream may be included by the originating codec, such as ID3 tags in the MP3 files.

The DAK serves as a security feature because it identifies to the receiver a legitimate BSP signal coming from the channel database. The DAK may be an encrypted string that is created by the TC 107, and authenticated by the transmitter and the receiver. A legitimate data-stream can be resolved by its key based on standard public-private key encryption standards similar to Pretty Good Privacy (PGP), RSA or other similar methods for secure communication. A hacker attempting to “steal” or “pirate” the use of a channel inside the BSP tower network array would fail at the receiver because the hacker-created DAK, would not match up with the private encryption key on the receiver. Persons attempting to transmit a “cloned” BSP signal from a non-BSP transmitter would also fail in that the encryption key on the data-stream would not work on the receiver. Persons attempting to transmit a destructive program or virus in the CDS segment, would also fail because the RF appliance would not install the data from an unauthenticated channel.

Pulsed OFDM

The BSP Digital transport method may use a modified Pulsed Orthogonal Frequency Division Multiplexing (P-OFDM) scheme. The version of P-OFDM is robust in handling channel bandwidth adjustments. Dynamically adjusting an in-use RF channel has been a technically insurmountable obstacle until recent silicon chip innovations in complexity and processing power. Previous to these advancements, the RF research and design work of the last fifty years has focused on integrating new technology on top of old methods of telecommunications. Cellular/mobile communications (TDMA, GSM and CDMA), DirecTV, PrimeStar, cable TV, IBOC radio, HDTV, etc., are pumping advanced solutions into an antiquated telecommunications system. The results are cost prohibitive telecommunications systems that require continual “upgrades” to maintain RF spectrum efficiency and improved channel density.

Three major advancements antiquate the current modes of system design and standardization: extremely powerful database structures, real-time network management of distant server clusters via broadband, and semiconductor integration of software re-programmable System on Chip (SoC) devices. A properly constructed RF standard, based on these three factors, is capable of overcoming almost all adverse conditions that can be encountered or created. Such a standard would work within existing RF channel structures and be capable of adding and removing RF band space dynamically with minimal hardware changes to the transmitters 109 and no changes to the receivers. The standard would also provide efficient dynamic channel bandwidth control to facilitate varying data-rates for different broadcasts. The RF transport method of the present invention is one such standard, as will be discussed in the next section. The RF transport method may also be narrow-channel, self-correcting, and software re-configurable to allow for easy adjustments to channel structure, modulation rates and application updates. The integration of these three advancements into a single SoC module defines the convergence bridge, which creates renewable RF telecommunication standards for the 21^{st} century.

BSP-OFDM

BSP-OFDM may be defined as the modified version of the P-OFDM method for transporting digital data-streams according to the present invention. It possesses specific features that are critical to the performance of the BSP broadcasting system. BSP-OFDM works by pulsating QAM symbols across several narrow-subchannels inside the main channel allocation structure. Two types of guarding on the subchannel framework provide clear RF reception at the receiver: time interval and RF spacing interval. The time interval, known as a frame, specifies the amount of time that the QAM symbols are transmitted. The spacing interval specifies the distance in Hertz from peak-to-peak between two adjacent subchannels. Together these two parameters enable a receiver to resolve each QAM symbol pulse on every subchannel.

Dynamics of BSP-OFDM

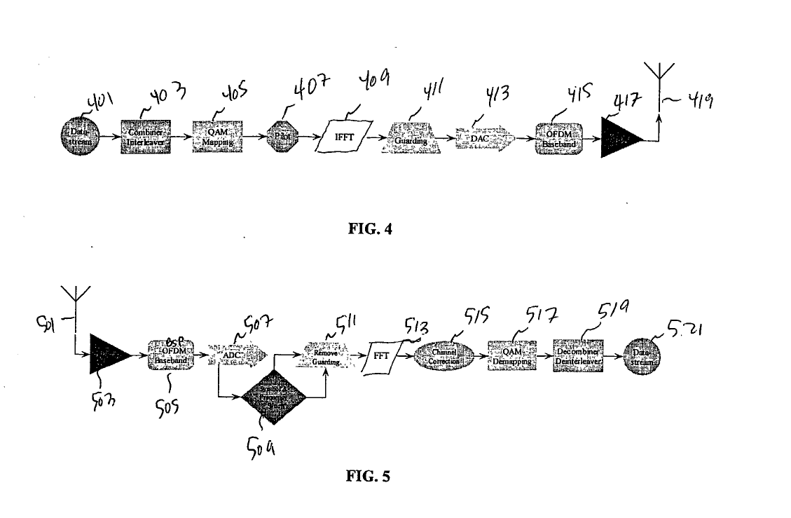

BSP-OFDM is not limited to a specific time interval or channel bandwidth. Subchannels in every BSP channel can be added or subtracted depending on the performance and desired data-rate of the channel. The channel structure for BSP radio includes Bricks and Corbels. The data-rate of any given channel may depend on four factors: channel size, QAM rate, pulsed time interval, and subchannel spacing. These parameters may be transmitted along with the Channel Frequency Identifier (CFI), from every BSP transmitter on the specific RF Allocation Control (RFAC) channel. This provides receivers with the necessary information to tune to any broadcast-stream coming from the transmitter. It also eliminates the need for receivers to “scan” for broadcast channels since tuning directly to the RFAC provides this information. The RFAC may transmits the CFI with all four parameters for every BSP channel in use. Up to 10 RFAC channels may be used so that no two adjacent transmitters use the same RFAC channel. The block diagram in FIG. 4 provides a general view of the RF transport method logic at the transmitter 400. The transmitter 400 may be used to broadcast the data stream 401. The transmitter may include a combiner/interleaver 403; a QAM modulator 405; a pilot signal generator 407; an Inverse Fast Fourier Transform DSP 409; a band guard insertion module 411; a digital-to-analog converter 413; a BSP-OFDM multiplexer 415; an amplifier 417; and an antenna 419.

Data Rates

The CFI specifies the starting or center frequency for the specific channel. The channel size parameter may be attached to the CFI in the form of Corbel-Brick units. The pulsed time interval is the amount of time a particular QAM signal is sent. This may be more properly called a “frame”. The subchannel spacing specifies the distance between each subcarrier's peak signals, much like the distance between two FM radio stations. For example, FM stations broadcasting at 101.3 and 101.5 are spaced 200 kHz away from each other. These definitions provide exactly the information that is required to calculate the needed values to broadcast a particular data-stream.

Calculation of data-rates is easy and uses key information to create a simple formula. The equation (C/W)*SF=D explains the theoretical data rate where “C” represents the BSP-OFDM channel size parameter and can be delineated in Hertz or Corbel-Bricks. Subchannels, or subcarriers, as they are known in OFDM terms, can be spaced in variable segments every “W” Hz inside the carrier channel structure. The “W” represents the peak-to-peak width or distance between two adjacent subcarriers and may range from 100 Hz to 2000 Hz in 100 Hz steps. The “S” represents the modulation Symbol rate where QAM rates range from 16 to 1024, and beyond. Pulsed time intervals of QAM symbols are measured in frame rates and are represented by “F”, ranging from 10 nanoseconds to 1000 milliseconds (which is equal to 1 second). The “D” represents the data-stream bit-rate of the particular channel.

The calculated theoretical rate, however, may not be indicative of the actual system performance. The loss in spectral efficiency may be approximated to be between 20% and 40%. This factor should then be figured in and is represented by “L” in the modified equation, which reads (C/W)*SFL=D. The equation (C/W)*SFL=D can be rearranged to solve for C, since this is the channel bandwidth that is needed for RF broadcasting. The rearranged equation reads DW/SFL=C. The DCD 101 also augments the data-stream with the KDS segment and CDS segment, if necessary, before forwarding the data-stream to the appropriate TCs 107. The TCs 107 send the fully concatenated data-stream to the transmitters with the CFI and four parametrics (channel size, modulation rate, time interval, and subcarrier spacing) attached to the data-stream for broadcasting.

One final adjustment to the equation may be performed to properly reflect the actual bandwidth needed to carry the concatenated data-stream, which includes the DDS, CDS and KDS segments. The KDS segment consumes an amount of space that is approximately 2-8 kbps in size. The CDS and DDS segments share the rest of the space in the channel, depending on the needs of the broadcaster. Normally, if a broadcaster wanted to deploy a codec with the data-stream, the CDS would consume 25-35% of the available throughput with the DDS consuming the rest, but this percentage is not fixed. The “D” factor in the equation should then include the fixed KDS segment and possibly the CDS segment along with the DDS. The final version of the expression reads (Ds+Ks+Cs)W/SFL=C. A few examples demonstrate how this data rate is calculated based upon possible parameters that the RFAC channel would transmit to the receivers.

### EXAMPLE A

An Internet radio broadcaster sends a 128 kbps data-stream of MP3 audio to the DCD 101 for nationwide broadcast. The CFI and four parametrics are set by the DCD 101 to 400 Hz for W, 64 QAM for the modulation Symbol rate S, 3.33 milliseconds for the frame rate F, and 70% efficiency for the Loss factor.

No codec transmission is necessary because all BSP receivers already contain the prolific MP3 codec, so the P factor is 0.9 (90%). In this example, the four parametrics are: Ds+Ks+Cs=128+8+0kbps=D kbps, W=400 Hz, S=6 bits/frame, F=300 frames/second, L=0.7, and P=0.9 (90% DDS, 10% KDS).

$$\frac{D \text{"bps"} \cdot W \text{"Hz"}}{\frac{S \text{"bits"}}{\text{"frame"}} \cdot \frac{F \text{"frames"}}{\text{sec}} \cdot L} = C \text{"Hz"}$$

$$\frac{136 , 000 \text{"bps"} \cdot 400 \text{"Hz"}}{\frac{6 \text{"bits"}}{\text{"frame"}} \cdot \frac{300 \text{"frames"}}{\text{sec}} \cdot 0.7} = C \text{"Hz"}$$

$$\frac{136 , 000 \cdot 400 \text{"Hz"}}{\frac{6}{1} \cdot \frac{300}{1} \cdot 0.7} = C \text{"Hz"}$$

$$\frac{54 , 400 , 000 \text{"Hz"}}{1260} = 43 , 174 \text{"Hz"}$$

2.6 cb=44“kHz”

In this example, a 2.6cb BSP channel would provide the bandwidth needed to transmit the 128 kbps MP3 audio data-stream.

### EXAMPLE B

A broadcaster transmits a 64 kbps WMA data-stream to the DCD 101. However, a new version of the codec is required to obtain CD-quality audio from this data-stream. The codec itself is 124 kilobytes in size. The broadcaster desires the codec deployment to take place in less than 5 seconds, so the data-rate of the CDS segment must be sufficient to contain the file every 5 seconds. The Cs variable in the D=Ds+Ks+Cs equation is determined to be 198,400 bps using the formula below.

$$\frac{124 , 000 \text{"bytes"} \cdot \frac{8 \text{"bits"}}{\text{"byte"}}}{5 sec} = CS \text{"bps"} = 198 , 400 \text{"bps"}$$

Together the Ds+Ks+Cs is equal to 64 kbps+8 kbps+199 kbps=271 kbps. Subcarriers will be slightly more compact in this example at 300 Hz (W), the Symbol rate will remain at 6 bits/frame (64 QAM), the frame rate S will drop to 3.0 milliseconds (333 frames/sec), and the efficiency factor will stand at 70%.

$$\frac{D \text{"bps"} \cdot W \text{"Hz"}}{\frac{S \text{"bits"}}{\text{"frame"}} \cdot \frac{F \text{"frames"}}{\text{sec}} \cdot L} = C \text{"Hz"}$$

$$\frac{271 , 000 \text{"bps"} \cdot 300 \text{"Hz"}}{\frac{6 \text{"bits"}}{\text{"frame"}} \cdot \frac{333 \text{"frames"}}{\text{sec}} \cdot 0.7} = C \text{"Hz"}$$

$$\frac{81 , 300 , 000 \text{"Hz"}}{1389.6} = 58 , 129 \text{"Hz"}$$

3.6 cb=60“kHz”

Both the 124-kilobyte codec and the 48 kbps WMA data-stream can be broadcast in a BSP channel only 60 kHz wide.

5. Digital Receiver Modules

BSP receivers may include a dual receiver design where one RF path is locked onto the RFAC while the other RF path tunes to the selected data-stream. By tracking the RFAC separately, receivers can track a broadcaster's data-stream from one location to another even if switching frequencies is required. A similar process takes place in the cellular industry when a handset is handed off from one base station to another based on several indicators such as the Received Signal Strength Indicator (RSSI). Consumers do not need to keep track of channel numbers or frequency numbers because the receiver always identifies the programming type and broadcaster source by name. The consumer interface may use LCD or other display technology, to list the available broadcast streams. FIG. 4 is a block diagram depicting the RF path of a BSP receiver 500. The receiver 500 may include an antenna 501; a low noise amplifier 503; a BSP-OFDM demultiplexer 505; an analog-to-digital converter 507; a symbol and frequency synchronizer 509; a guard band removal circuit 511; a Fast Fourier Transform DSP 513; an error control decoder 515; a QAM demodulator 517; a decombiner/deinterleaver 519; and an output of the data stream 521.

RFAC Examined

The BSP receiver may be defined as a receiver designed to receive and decode channels transmitted by the BSP. The receiver will also be referred to as a Digital Receiver Module (DRM). When a DRM is turned on, it automatically scans and finds the active RFAC channel by scanning through a specific list of possible RFAC locations in the RF spectrum. This list of possible locations can be updated by a valid RFAC to modify the areas the receiver should look for other RFAC channels. The DRM may attempt to demodulate the RFAC using a priority list of QAM rates. For example, the initial list might be in this order: 64, 32, 16, 128, 256, and 512. This list can also be updated by a valid RFAC for future use. The DRM may also include a predetermined list of channel bandwidths to demodulate the RFAC from. This list can also be updated through a valid RFAC channel. The initial list may, for example, be 4.0 cb, 8.0 cb 10.0 cb, 0.8 cb, and 2.0 cb.

The RFAC channel provides the receiver with a list of available channels plus the five parametrics for each channel, which are center frequency, channel bandwidth size, modulation rate, frame rate, and subcarrier spacing. When a particular channel becomes too weak for clear reception, the DRM can be programmed by the user to either switch to a data-stream of similar content or to do what the electronics manufacturers decide is best for their products. Consumers may be able to move about from coast to coast listening to the same content provider because the DRM has automatically changed channels to the same content provider whenever possible.

Consumer Benefits

DRMs may be integrated into any RF appliance. The appliances may include MP3 players, portable boom-boxes, car stereos, cell phones, PDAs, USB & PCI devices on computers, walkmans, CD players, TVs, HDTVs, clock radios, deck receivers, DVD players, satellite receivers, VHS players, set-top boxes and computer monitors. Any DRM can receive codec updates. Codec upgrades may be downloaded into the receivers through the RFAC. If a codec is present in the RFAC that is not installed on the DRM, it will be installed after the DAK is authenticated. A receiver may also install a codec from the CDS segment when a broadcaster elects to use that method for codec deployment. Malicious attacks on DRM-enabled RF appliances may be stopped during the DAK authentication process.

Any type of data that can be compressed and decompressed can be transmitted over the BSP Digital broadcasting system. Surround Sound, 5.1, 4.1, digital TV, and other enhancements may be viewed on BSP receivers with the respective codec and proper user interface, such as an LCD screen. A broadcaster can use a text and graphics codec to relay information like stock ticker tapes, AP news feeds, weather service information, TDD services, advertising, or any other information that can be compressed and decompressed by a codec. The BSP transmission is not just a replacement of the analog radio and TV signals; it is a complete digital convergence solution for all consumer entertainment and educational needs. There is no limitation to the type of codec a broadcaster may use, as long as it is transmittable in a reasonable and prescribed amount of time, for example, no longer than 30-45 seconds. BSP enabled RF appliances also have the ability to record broadcast data-streams for future playback.

Digital Rights Management

Digital rights management is a very sensitive subject for content creators, producers, broadcasters and consumers. The list below briefly defines the methods for protecting copyright holders while not displeasing the broadcasters and consumers.

1) License fee paid to copyright holder for content played (current broadcast radio and TV method)

2) General license fee per receiver at the time of purchase.

3) Optionally disallow recording of content by DRM from particular broadcasters.

4) Encrypt DRM recorded content to only play on certain BSP-enabled software and devices.

Pay-Per-Channel

In cases where broadcasters desire to charge a fee for reception, the following scheme provides that functionality. Every BSP receiver may include a unique 64-bit ID and 128-bit encrypted key. A consumer can sign up for pay channels via the web or toll-free number. The consumer need only know the serial number of all BSP receivers they wish to get the pay channel on and have a method of payment such as a credit card, etc. Consumers can then select exactly which channel or channels they want and pay a per channel per device fee of, say $0.25 to $1.00, depending on the number of receivers and the price structure of the broadcaster. For example, some broadcasters may allow up to 4 receivers each time a $1.00 fee is paid for a particular channel. Within 15-30 minutes the DCD 101 would transmit the authorization codes for the specific pay channels on the specific receivers. The DCD 101 authorization codes may include the 64-bit ID, the 128-bit encrypted key, and every 20-bit station ID string that the consumer has paid for. Every 3-5 days the authorization codes may be re-transmitted again allowing continued reception of the pay channels. After a reasonable period, for example 6-10 days, if the BSP radio has not received authorization codes for a specific channel, the receiver would shut off access to that channel. If problems existed where a legitimate consumer has paid for a channel but was not receiving it, the consumer would contact BSP customer support via the web or toll-free number and have the authorization codes transmitted within 15-20 minutes.

While this invention has been described in conjunction with the specific embodiments outlined above, it is evident that many alternatives, modifications and variations are apparent to those skilled in the art. Accordingly, the preferred embodiments of the invention as set forth above are intended to be illustrative and not limiting. Various changes may be made without departing from the spirit and scope of the invention.

What is claimed is:

1. A system for providing broadcasting services, comprising:
a digital channel database for storing a program from a broadcaster;
a computer network for accessing and distributing the program as a data stream;
a tower controller for receiving the program data stream from the computer network; and
at least one transmitter selected by the tower controller to receive the data stream and to broadcast the program to end-user receivers.

2. The system of claim 1, wherein the content provider accesses at least one of the following types of information from the digital channel database:
bit-rate availability in a location of an end-user receiver;
a graphical view of an RF saturation pattern in said location;
a cost of service for each transmitter from the at least one transmitter; and
end-user demographics in said location.

3. The system of claim 1, wherein the data-stream is cached at the digital channel database for gradual release to the end-user receivers at a time specified by the broadcaster.

4. The system of claim 1, wherein after the data-stream arrives at the tower controller, the tower controller attaches security and control parameters to the data-stream before forwarding the data-stream to the transmitters.

5. The system of claim 4, wherein said parameters include at least one of the following:
a data-stream authentication key;
a codec;
RF transmission control data for said data-stream; or
pay-per-channel receiver identification.

6. The system of claim 1, wherein the data stream received by the transmitter includes a data-stream authentication key, a specific receiver ID key, and a pay-per-channel authorization key.

7. The system of claim 1, wherein the transmitter is a software controlled RF signal transmitters using a plurality of parametrics sent by the tower controller for transmission of the data stream.

8. The system of claim 7, wherein the plurality of parametrics comprise:
channel center frequency;
channel width;
subcarrier spacing;
symbol rate; and
frame rate.

9. The system of claim 7, wherein the parametrics are sent by the tower controller via a control channel that constantly outputs the parametrics for said data stream and for other data streams relayed by the tower controller.

10. The system of claim 6, wherein the data-stream authentication key is a key created by the tower controller for every data stream it transmits.

11. The system of claim 6, wherein the data-stream identification key is identified and decrypted by the transmitter to verify that the data-stream is legitimate and that a decryption key used to decrypt the data-stream identification key works.

12. The system of claim 11, wherein the transmitter informs the tower controller that the decryption of the data-stream authentication key has failed.

13. The system of claim 1, wherein the broadcaster desiring to reach a specific geographical location for broadcasting the program selects through the digital channel database, which transmitters from the at least one transmitter the broadcaster wants the program transmitted from.

14. The system of claim 1, wherein the program is transmitted by the transmitter over a first RF channel and the digital channel database sends instructions via a control channel to the transmitter to move the program to a second RF channel when said first RF channel becomes unusable.

15. The system of claim 1, wherein the program is transmitted by the transmitter over a first RF channel and the transmitter reports to the digital channel database a continuity of channel performance by monitoring the RF spectrum in the end-users' location for signal interference.

16. The system of claim 1, wherein the broadcaster produces the program content with a codec.

17. The system of claim 16, wherein the end-user receiver receives the codec via a control channel in association with the data-stream, authenticates the codec with a data-stream identification key, installs the codec into a library of codecs, and plays the program using the codec.

18. The system of claim 1, wherein the transmitter transmit the program over a channel that includes a digital data stream segment and a key data stream.

19. The system of claim 18, wherein the digital data stream segment varies in width depending on a data rate of the data-stream.

20. The system of claim 18, wherein the transmitter transmits the digital data stream segment according to bandwidth specification set by the tower controller.

21. The system of claim 20, wherein the bandwidth is calculated by the digital channel database.

22. The system of claim 18, wherein the key data stream segment includes broadcaster identification information and channel authentication information.

23. The system of claim 18, wherein the end-user receiver first resolves the key data stream before demodulating the data contained in the digital data stream.

24. The system of claim 18, wherein the transmitter transmits a same OFDM symbol multiple times in succession.

25. The system of claim 24, wherein the OFDM symbols can be averaged by the end user receiver for error correction.
